(19) United States
(12) Patent Application Publication
(10) Pub. No.: US 2010/0162900 A1
(43) Pub. Date: Jul. 1, 2010

(54) BEVERAGE MAKE COMPRISING A PAD HOLDER WHICH CAN BE CONNECTED TO A BREW CHAMBER TOP PORTION THROUGH A BAYONET CONNECTION

(75) Inventor: Thewis M. Westra, Hoogeveen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,005

(22) PCT Filed: Aug. 9, 2007
(86) PCT No.: PCT/IB07/53157

§ 371 Date: Feb. 10, 2009

(30) Foreign Application Priority Data
Aug. 14, 2006 (EP) 06118879.3

(51) Int. Cl. A47J 31/44

(52) U.S. Cl. 99/323

(57) ABSTRACT

A coffee maker (1) has a pad holder (30) for receiving and supporting at least one coffee pad (10), which holder can be connected to a brew chamber top portion (40) of the coffee maker via a bayonet connection. Both the pad holder (30) and the brew chamber top portion (40) are provided with bayonet ridges (50, 60), contacting surfaces (51, 61) of the bayonet ridges (50, 60) comprising at least two portions (52, 53, 62, 63, 64) having an inclined orientation with respect to each other. In establishing a coupling of the pad holder to the brew chamber top portion or detaching such a coupling, the pad holder is rotated with respect to the brew chamber top portion, during which a portion (53) of the contacting surface (51) of the bayonet ridges (50) of the pad holder plays an important role in guiding the pad holder such that a height level of the pad holder with respect to the brew chamber top portion is varied automatically.

### FIELD OF THE INVENTION

The present invention relates to a device for making a beverage such as coffee from an extractable material and water that is forced through the extractable material, comprising a brew chamber having a brew chamber casing that encloses a brew chamber space intended for containing a quantity of the extractable material, wherein the brew chamber casing comprises at least two portions which can be mutually connected by means of a bayonet connection, wherein the two casing portions are provided with spaced-apart bayonet ridges, wherein the bayonet ridges of the two casing portions are designed to engage each other when the bayonet ridges are put in contact with each other and the casing portions are rotated with respect to each other, and wherein each bayonet ridge comprises a surface which is suitable for contacting another bayonet ridge.

### BACKGROUND OF THE INVENTION

A beverage maker as mentioned in the opening paragraph is known. It is common practice especially in the field of espresso machines to have a holder for receiving and holding a quantity of ground coffee beans, which holder can be connected to another component of the machine via a bayonet connection. When the holder is put in place and the connection has been established, a space in which the ground coffee beans are present is sealed. The espresso is made by forcing water under pressure through this space.

In many cases, the holder is a metal part comprising two bayonet ridges. In view of the high pressure prevailing during the espresso-making process, strength and stiffness of the material of the holder need to be quite high, and it is not possible for the holder to be manufactured from synthetic resin. Furthermore, it is quite difficult and inconvenient in the existing machines to put the holder in place and lock it correctly, skilled personnel being needed for operating the machines. Therefore, the possibility of using a bayonet connection for locking the holder in the machine has not yet been applied in beverage makers especially intended for home use. Instead, a compartment for receiving the holder is provided in such beverage makers with a hinging opening and closing mechanism or with a drawer system. A disadvantage of these beverage makers is that they comprise a substantial number of moving and heavy parts, and that the parts need to have exactly defined dimensions in order to fulfill requirements of the compartment for receiving the holder. Consequently, the beverage makers are sensitive to deviations in part dimensions, and the manufacture of the beverage makers involves high costs.

### SUMMARY OF THE INVENTION

It is an object of the present invention to provide a beverage maker in which the holder can be connected to another component of the beverage maker by means of a bayonet connection, wherein the way in which the connection is established is so simple that the beverage maker is suitable for use as a home appliance. The object is achieved by a beverage maker as mentioned in the opening paragraph, wherein the contacting surface of the bayonet ridge comprises at least two portions having an inclined orientation with respect to each other.

According to the present invention, the bayonet ridges of the portions of the brew chamber casing, which may be a holder for receiving and holding a quantity of extractable material and a top portion of the brew chamber, have a special shape, such that a contacting surface of the bayonet ridges comprises at least two portions having an inclined orientation with respect to each other. Therefore, when the present invention is applied, it is possible to have bayonet ridges in which one of the portions of the contacting surface extends in a plane perpendicular to an axis of rotation about which the brew chamber casing portions are rotatable with respect to each other, and in which another one of the portions of the contacting surface extends in another plane, i.e. a plane which is inclined with respect to the plane associated with a rotation movement of the casing portions. In the following, for the sake of clarity, the portion of the contacting surface which extends in a plane perpendicular to an axis of rotation about which the casing portions are rotatable with respect to each other is referred to as the horizontal portion, whereas the other portion of the contacting surface will be referred to as the inclined portion.

When the contacting surface of the bayonet ridges has a horizontal portion and an inclined portion as described in the foregoing, the bayonet connection is established in a manner which resembles the manner in which a screw thread connection is established. In particular, assuming that all bayonet ridges are positioned in a similar manner, a connection between two bayonet ridges is established by causing the inclined portion of the contacting surface of one of the bayonet ridges to slide along the other bayonet ridge first, as a result of which the first bayonet ridge is lifted with respect to the other bayonet ridge. As soon as the horizontal portion of the contacting surface of the first bayonet ridge is at a level right above the horizontal portion of the contacting surface of the other bayonet ridge, said portions of the contacting surfaces of the bayonet ridges will slide along each other, until the inclined portions of the contacting surfaces of the bayonet ridges touch each other. In this way, the movement of the bayonet ridges with respect to each other is well-defined on the basis of the geometry of the contacting surface.

If one of the casing portions is a removable holder, it is easy for a user to put the holder in the right place in the beverage maker and to lock the holder in the beverage maker in the right manner, as the required movement of the holder is dictated by the specific shape of the bayonet ridges. In particular, the inclined portion of the contacting surface of the bayonet ridges is used for guiding the movement of the holder, while the horizontal portion of the contacting surface is used for locking the holder. All that a user needs to do for the purpose of establishing the bayonet connection is to insert the holder in the beverage maker in the correct orientation and to rotate the holder over a defined length. Preferably, the holder is provided with a handle for easy manipulation.

Advantageously, the contacting surface of the bayonet ridges of one of the casing portions comprises at least three portions having an inclined orientation with respect to each other, such that one of these portions has a substantially parallel orientation with respect to a portion of the contacting surface of the bayonet ridges of another one of the casing portions when the casing portions are in a position for connecting to each other. In particular, the contacting surface of the first bayonet ridge may comprise one horizontal portion and two inclined portions, and the inclined portions are positioned on either side of the horizontal portion. In that case, when the inclined portion of the contacting surface of the other bayonet ridge slides along the first bayonet ridge, the inclined portion of the contacting surface of the other bayonet ridge is in contact with an inclined portion of the contacting surface of the first bayonet ridge, so that a situation in which the inclined portion of the contacting surface of the other bayonet ridge needs to slide along a sharp edge of the first bayonet ridge is avoided. In fact, the inclined portion of the contacting surface of the first bayonet ridge serves as a ramp. Furthermore, the substantially parallel orientation of the inclined portions of the contacting surfaces of the bayonet ridges avoids the risk of the casing portions tending to tilt with respect to each other when the inclined portions arc contacting each other.

In a preferred embodiment of the beverage maker according to the present invention, each casing portion is provided with at least three bayonet ridges. In that case, the casing portions, including the bayonet ridges, may be manufactured from a synthetic resin material. If the bayonet connection is formed by at least three bayonet ridges, the connection is strong enough to withstand the pressures prevailing during usual beverage-making processes.

The present invention also relates to a component for use in a device for making a beverage such as coffee from an extractable material and water that is forced through the extractable material, which component is intended to be applied as a portion of a casing of a brew chamber of the beverage maker, which casing serves for enclosing a brew chamber space which is intended for containing a quantity of the extractable material, the component comprising bayonet ridges, wherein each bayonet ridge comprises a surface which comprises at least two portions having an inclined orientation with respect to each other. For example, this component may be a removable holder for receiving and holding a quantity of the extractable material which is used in the process of making the beverage.

The above and other aspects of the present invention will be apparent from and elucidated with reference to an embodiment of a coffee maker as described hereinafter.

### BRIEF DESCRIPTION OF THE DRAWINGS

The present invention will now be explained in greater detail with reference to the Figures, in which equal or similar parts are indicated by the same reference signs, and in which:

FIG. 1 diagrammatically shows components of a coffee maker according to a preferred embodiment of the present invention, which comprises a brew chamber for receiving and accommodating at least one coffee pad, wherein the brew chamber comprises a pad holder and a top portion;

FIG. 2 is a perspective view of the pad holder and the brew chamber top portion of the coffee maker shown in FIG. 1;

FIG. 3 is a perspective view of parts of the pad holder and the brew chamber top portion of the coffee maker shown in FIG. 1;

FIG. 4 illustrates a closing movement of the pad holder and the brew chamber top portion of the coffee maker shown in FIG. 1;

FIG. 5 illustrates a closed position of the pad holder and the brew chamber top portion of the coffee maker shown in FIG. 1; and

FIG. 6 illustrates an opening movement of the pad holder and the brew chamber top portion of the coffee maker shown in FIG. 1.

### DETAILED DESCRIPTION OF AN EMBODIMENT

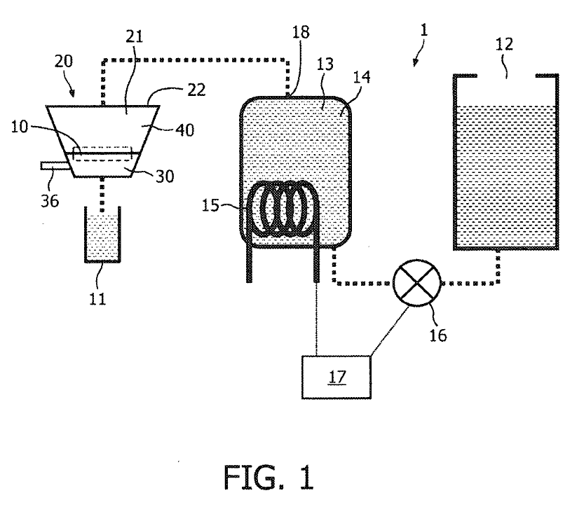

FIG. 1 diagrammatically shows components of a coffee maker 1 according to a preferred embodiment of the present invention. The coffee maker 1 is suitable for making coffee from hot water and a pad 10 filled with ground coffee beans. Besides the components of the coffee maker 1, FIG. 1 also shows a container 11 such as a cup for receiving the coffee from the coffee maker 1.

The coffee maker 1 comprises a water tank 12 for containing water, a boiler 13 having an interior space 14 for containing water and a heating element 15 for supplying heat to the water, a pump 16 for pumping water from the water tank 12 to the boiler 13, and a sealable brew chamber 20 for receiving and accommodating at least one coffee pad 10. In FIG. 1, the coffee pad 10 is shown by means of dashed lines, indicating the fact that the coffee pad 10 is located in an internal space 21 of the brew chamber 20 enclosed by a casing 22 of the brew chamber 20.

A user wanting to make coffee with the coffee maker 1 inserts a coffee pad 10 into the brew chamber 20 and activates the coffee maker I. As a first step in a process of making coffee, the water inside the boiler 13 is heated by the heating element 15. When the temperature of the water has reached a predetermined level, the pump 16 may be activated, so that cold water is transported from the water tank 12 to the boiler 13, and hot water is transported from the boiler 13 to the brew chamber 20. In a second step of the process of making coffee, an interaction takes place inside the brew chamber 20 between the hot water and the quantity of ground coffee beans present in the coffee pad 10. As a result, hot coffee is obtained, which flows from the brew chamber 20 to the cup 11. The quantity of the water that is used in the process of making coffee is adapted to the quantity of ground coffee beans that is used. In FIG. 1, a path of the water through the coffee maker 1 is diagrammatically depicted with a dotted line.

The coffee maker 1 comprises suitable control means 17 for controlling the operation of the various components, especially the heating element 15 and the pump 16. The control means 17 are diagrammatically depicted in FIG. 1, and control signals transmitted by the control means 17 to the heating clement 15 and the pump 16 during operation of the coffee maker 1 arc represented by dotted lines.

Any suitable control means 17 may be applied, and these may be adapted to control the operation of the coffee maker 1 in any suitable manner within the scope of the present invention. Depending on the extent to which input from a user of the coffee maker is needed, the control means 17 may be used to switch the heating element 15 on and off automatically, for example on the basis of a comparison of a desired temperature of water present inside the boiler 13 and an actual temperature of the water. Furthermore, the control means 17 may be used to switch on the pump 16 automatically, for example when water present inside the boiler 13 has reached a desired temperature, and to terminate a pumping action automatically when a predetermined period of time has lapsed.

The casing 22 of the brew chamber 20 comprises two portions, namely a pad holder 30 and a top portion 40. The pad holder 30 is removably arranged with respect to the brew chamber top portion 40 and is adapted to receive and support at least one coffee pad 10. The pad holder 30 makes it very easy for a user of the coffee maker 1 to insert at least one coffee pad 10 into the internal space 21 of the brew chamber 20. All that the user needs to do is take the pad holder 30, place the coffee pad(s) 10 on the pad holder 30, and put the pad holder 30 in place in the coffee maker 1.

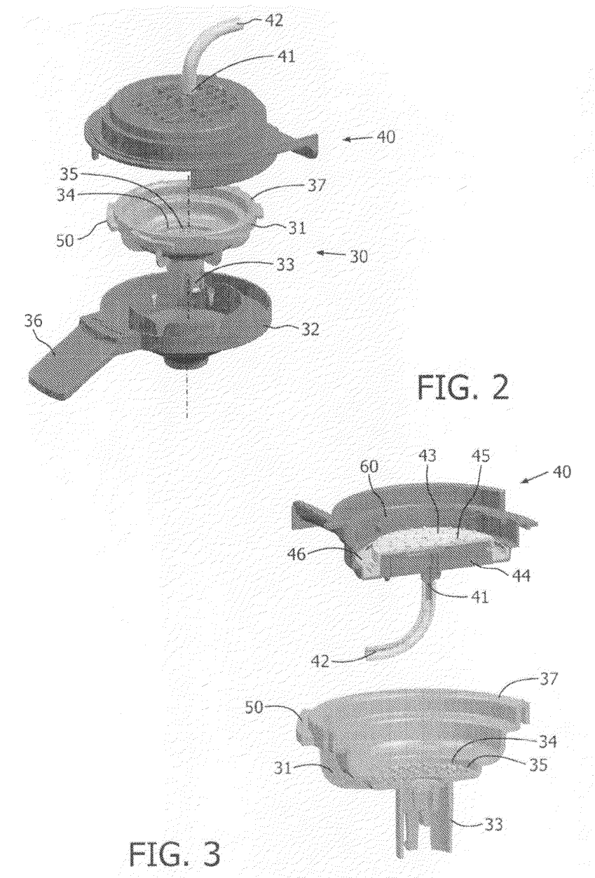

When the pump 16 is activated for the purpose of displacing water through the coffee maker 1 during operation of the coffee maker 1, hot water is forced through the internal space 21 of the brew chamber 20, and a pressure is built up in the internal space 21. Therefore, it is important that the brew chamber 20 is sealable, and that the pad holder 30 can be connected to the brew chamber top portion 40 in a secure manner. The present invention relates to the connection of the pad holder 30 to the brew chamber top portion 40, as will be further explained on the basis of FIGS. 2 to 6. It is noted that FIG. 2 shows the pad holder 30 and the brew chamber top portion 40 and that FIG. 3 only shows parts of the pad holder 30 and the brew chamber top portion 40.

FIGS. 2 and 3 show that the brew chamber top portion 40 has a water inlet member 41 and that a hose 42 is connected to this water inlet member 41. The hose 42 is connected to a water outlet 18 of the boiler 13 and serves for conducting water from the boiler 13 to the brew chamber 20 when the pump 16 is operated. The brew chamber top portion 40 has a shape which is comparable to the shape of a cup, an open side of the brew chamber top portion 40 being at a lower side of the brew chamber top portion 40 in a normal orientation of the coffee maker 1. At an upper side of the brew chamber top portion 40, a distributor member 43 is arranged, which comprises a distributor space 44 for containing water and holes 45 for allowing water to leave the distributor space 44. The distributor member 43 is arranged such that the water inlet member 41 provides access to the distributor space 44. Hence, during a pumping action, the distributor space 44 is filled with water, which water is distributed over the coffee pad(s) 10 as it exits the distributor space 44 through the holes 45.

In the example shown, the pad holder 30 comprises two portions, namely a pad-supporting portion 31 and a handle portion 32. The pad-supporting portion 31 has a shape which is comparable to the shape of a cup, with a hollow cylinder extending from its bottom. In a normal orientation of the coffee maker 1, an open side of the pad-supporting portion 31 is at an upper side of the pad-supporting portion 31. The element of the pad-supporting portion 31 which is shaped like a hollow cylinder is a water outlet member 33. Studs 35 for supporting coffee pad(s) 10 are arranged at a bottom 34 of the pad supporting portion 30.

The handle portion 32 serves for carrying the pad-supporting portion 31 and has a handle 36 which may be gripped by a user of the coffee maker 1. The presence of the handle 36 makes it easy and convenient for the user to manipulate the pad holder 30. It is noted that, within the scope of the present invention, it is not necessary for the pad holder 30 to comprise more than one portion.

For the purpose of closing the brew chamber 20, the pad holder 30 needs to be partially inserted into the brew chamber top portion 40. In order to avoid water leakage from the brew chamber 20 when the brew chamber 20 is in the closed condition, a sealing ring 46 is provided, which is arranged in the brew chamber top portion 40 at the side where the water inlet member 41 is present and which surrounds the distribution member 43. A connection between the pad holder 30 and the brew chamber top portion 40 is complete and sealed when an upper rim 37 of the pad holder 30 is in contact with the sealing ring 46.

The pad holder 30 can be connected to the brew chamber top portion 40 by a bayonet connection. To this end, both the pad holder 30 and the brew chamber top portion 40 comprise spaced-apart bayonet ridges 50, 60, the connection between the pad holder 30 and the brew chamber top portion 40 being obtained when the following steps are carried out:
1) positioning the pad holder 30 under the brew chamber top portion 40;
2) moving the pad holder 30 in an upward direction until the upper rim 37 of the pad holder 30 touches the sealing ring 46; and
3) rotating the pad holder 30.

The pad holder 30 is positioned with respect to the brew chamber top portion 40 such that, when the pad holder 30 is moved in an upward direction, portions of the bayonet ridges 50 of the pad holder 30 move through the spaces present between the bayonet ridges 60 of the brew chamber top portion 40. Hence, it is possible to move the bayonet ridges 50 of the pad holder 30 to beyond the bayonet ridges 60 of the brew chamber top portion 40. When the pad holder 30 is subsequently rotated, the bayonet ridges 50 of the pad holder 30 are put in a position right above the bayonet ridges 60 of the brew chamber top portion 40. In this position, the bayonet ridges 50 of the pad holder 30 are supported by the bayonet ridges 60 of the brew chamber top portion 40, as a result of which a secure connection between the pad holder 30 and the brew chamber top portion 40 is obtained. When the pad holder 30 and the brew chamber top portion 40 are connected in this way, the brew chamber 20 is sealed and suitable to be provided with hot water under pressure.

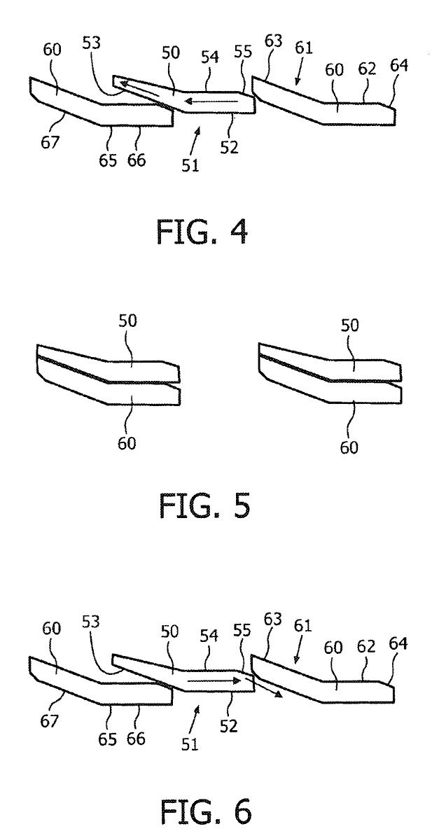

The shape of the bayonet ridges 50, 60 of the pad holder 30 and the brew chamber top portion 40, and the way in which the bayonet ridges 50, 60 may be moved and positioned with respect to each other, are explained in more detail on the basis of FIGS. 4 to 6.

Within the context of the present invention, the shape of a contacting surface 51, 61 of the bayonet ridges 50, 60, i.e. a surface 51, 61 of the bayonet ridge 50, 60 which is suitable for contacting a surface 51, 61 of another bayonet ridge 50, 60, is particularly relevant. FIGS. 4 to 6 clearly show that the bayonet ridges 50 of the pad holder 30 comprise a contacting surface 51 having two portions 52, 53 which have an inclined orientation with respect to each other. One of the two portions 52, 53 extends in a plane perpendicular to an axis of rotation about which the pad holder 30 is rotatable with respect to the brew chamber top portion 40. This portion 52 of the contacting surface 51 of the bayonet ridge 50 will be referred to below as the horizontal portion 52, while the other portion 53 of the contacting surface 51 of the bayonet ridge 50 will be referred to as the inclined portion 53.

Furthermore, FIGS. 4 to 6 clearly show that the bayonet ridges 60 of the brew chamber top portion 40 comprise a contacting surface 61 having three portions 62, 63, 64. Like the contacting surface 51 of the bayonet ridges 50 of the pad holder 30, the contacting surface 61 of the bayonet ridges 60 of the brew chamber top portion 40 comprises a horizontal portion 62 and an inclined portion 63, more or less like a mirrored image of the contacting surface 51 of the bayonet ridge 50 of the pad holder 30. At a side of the horizontal portion 62 other than the side where the inclined portion 63 is connected to the horizontal portion 62, another inclined portion 64 is arranged. For sake of clarity this inclined portion 64 will be referred to as ramp portion 64 below. In the example shown, the ramp portion 64 extends substantially parallel to the inclined portion 53 of the contacting surface 51 of the bayonet ridge 50 of the pad holder 30 when the pad holder 30 and the brew chamber top portion 40 are in a correct position with respect to each other.

It is noted that a shape of an upper surface 54 of the bayonet ridges 50 of the pad holder 30, which surface 54 is located at a different side of the bayonet ridges 50 than the contacting surface 51, resembles the shape of the contacting surface 61 of the bayonet ridges 60 of the brew chamber top portion 40. The upper surface 54 of the bayonet ridges 50 of the pad holder 30 thus also comprises a ramp portion 55. Furthermore, it is noted that a lower surface 65 of the bayonet ridges 60 of the brew chamber top portion 40, which surface 65 is located at a different side of the bayonet ridges 60 than the contacting surface 61, comprises among other things a horizontal portion 66 and an inclined portion 67.

FIG. 4 illustrates a closing movement of the pad holder 30 and the brew chamber portion 40. In particular, a movement of the pad holder 30 with respect to the brew chamber top portion 40 is indicated by means of two arrows. First the pad holder 30 is moved upward until the ramp portion 55 of the upper surface 54 of the bayonet ridge 50 of the pad holder 30 contacts the inclined portion 67 of the lower surface 65 of the bayonet ridge 60 of the brew chamber top portion 40. Secondly, the pad holder 30 is rotated such that the bayonet ridge 50 of the pad holder 30 is moved to the left in FIG. 4. In the process, the ramp portion 55 of the upper surface 54 of the bayonet ridge 50 of the pad holder 30 slides along the inclined portion 67 of the lower surface 65 of the bayonet ridge 60 of the brew chamber top portion 40, while at the same time the inclined portion 53 of the contacting surface 51 of the bayonet ridge 50 of the pad holder 30 slides along the ramp portion 64 of the contacting surface 61 of the bayonet ridge 60 of the brew chamber top portion 40. At a given moment illustrated by FIG. 4, the contact between the ramp portion 55 of the upper surface 54 of the bayonet ridge 50 of the pad holder 30 and the inclined portion 67 of the lower surface 65 of the bayonet ridge 60 of the brew chamber top portion 40 is lost, while the sliding movement of the inclined portion 53 of the contacting surface 51 of the bayonet ridge 50 of the pad holder 30 along the ramp portion 64 of the contacting surface 61 of the bayonet ridge 60 of the brew chamber top portion 40 is maintained.

The pad holder 30 is lifted during the rotary movement owing to the fact that the surface portions 53, 64 slide along each other. The lifting process is continued until the horizontal portion 52 of the contacting surface 51 of the bayonet ridge 50 of the pad holder 30 is at the same level as the horizontal portion 62 of the contacting surface 61 of the bayonet ridge 60 of the brew chamber top portion 40. From that moment on, the horizontal portions 52, 62 slide along each other until the inclined portion 53 of the contacting surface 51 of the bayonet ridge 50 of the pad holder 30 abuts against the inclined portion 63 of the contacting surface 61 of the bayonet ridge 60 of the brew chamber top portion 40. The obtained mutual positions of the bayonet ridges 50, 60 of the pad holder 30 and the brew chamber top portion 40 are shown in FIG. 5. In this mutual arrangement, the connection of the pad holder 30 to the brew chamber top portion 40 is complete and is strong enough to withstand the pressures associated with a coffee-making process.

When the pad holder 30 is to be detached from the brew chamber top portion 40, the steps of the above process of establishing the connection of the pad holder 30 to the brew chamber top portion 40 are performed in reverse order. This is illustrated by FIG. 6, in which a movement of the pad holder 30 with respect to the brew chamber top portion 40 is indicated by means of two arrows. First the pad holder 30 is rotated such that the bayonet ridge 50 of the pad holder 30 is moved to the right in FIG. 6. In the process, the horizontal portion 52 of the contacting surface 51 of the bayonet ridge 50 of the pad holder 30 slides along the horizontal portion 62 of the contacting surface 61 of the bayonet ridge 60 of the brew chamber top portion 40. At a later stage during the rotary movement, the contact between the horizontal portion 52 of the contacting surface 51 of the bayonet ridge 50 of the pad holder 30 and the horizontal portion 62 of the contacting surface 61 of the bayonet ridge 60 of the brew chamber top portion 40 is lost, and the inclined portion 53 of the contacting surface 50 of the bayonet ridge 50 of the pad holder 30 starts sliding along the ramp portion 64 of the contacting surface 60 of the bayonet ridge 60 of the brew chamber top portion 40. As a result, the pad holder 30 is not only rotated, but also starts moving downward. At yet a later stage during the rotary movement, an additional guiding of the bayonet ridge 50 of the pad holder 30 is realized, i.e. in that the ramp portion 55 of the upper surface 54 contacts the inclined portion 67 of the lower surface 65 of the bayonet ridge 60 of the brew chamber top portion 40. At a certain moment, there is no part of the bayonet ridge 50 of the pad holder 30 which is above the bayonet ridge 60 of the brew chamber top portion 40 any more, and the pad holder 30 may be freely moved downward.

It is clear from the above description of the way in which the bayonet ridges 50, 60 are moved with respect to each other when it is desired to attach the pad holder 30 to the brew chamber top portion 40, or to detach the pad holder 30 from the brew chamber top portion 40, that the necessary mutual movement of the pad holder 30 and the brew chamber top portion 40 is dictated by the specific shape of the surfaces 51, 54, 61, 65 of the bayonet ridges 50, 60. For establishing a connection between the pad holder 30 and the brew chamber top portion 40, a user of the coffee maker 1 only needs to put the pad holder 30 in the correct initial position with respect to the brew chamber top portion 40 and to rotate the pad holder 30 with respect to the brew chamber top portion 40, preferably by taking hold of the handle 36. There is no need for the user to exert a force for lifting the pad holder 30, as the pad holder 30 will be lifted automatically as a consequence of the rotation movement. In this respect, the process of establishing the bayonet connection resembles a process of establishing a screw thread connection. For detaching the pad holder 30 from the brew chamber top portion 40, a user of the coffee maker 1 only needs to rotate the pad holder 30 with respect to the brew chamber top portion 40 in a direction opposed to the direction associated with establishing the connection between the pad holder 30 and the brew chamber top portion 40.

An important advantage of the use of the bayonet ridges 50, 60 as described above is that a user of the coffee maker 1 does not experience any difficulties when connecting the pad holder 30 to the brew chamber top portion 40, or when detaching the pad holder 30 from the brew chamber top portion 40. There is only one way in which the bayonet ridges 50, 60 of the pad holder 30 and the brew chamber top portion 40 can be moved along each other. All that the user needs to do is to take hold of the handle 36 of the pad holder 30 and rotate the pad holder 30 in the relevant direction.

In the example shown, both the pad holder 30 and the brew chamber top portion 40 are provided with six bayonet ridges 50, 60. This does not alter the fact that the number of bayonet ridges 50, 60 may also be less than six or more than six. Preferably, the number of bayonet ridges 50, 60 is at least three, as in that case the pad holder 30 and the brew chamber top portion 40, including the bayonet ridges 50, 60, can be manufactured from a synthetic resin material while the connection of the pad holder 30 to the brew chamber top portion 40 is still strong enough for withstanding the pressures associated with a coffee-making process. It is also advantageous if each of the pad holder 30 and the brew chamber top portion 40 comprises at least four bayonet ridges 50, 60.

It will be clear to those skilled in the art that the scope of the present invention is not limited to the examples discussed above, but that various amendments thereto and modifications thereof are possible without deviating from the scope of the present invention as defined in the attached claims. While the present invention has been illustrated and described in detail in the Figures and the description, such illustration and description are to be considered illustrative or exemplary only, and not restrictive. The present invention is not limited to the disclosed embodiments.

The fact that the present invention is described as being applied in a coffee maker 1 should not be understood such as to imply that other applications of the present invention are excluded. The present invention may indeed be applied in any other type of beverage maker having a brew chamber 20 which comprises at least two portions 30, 40 which can be interconnected via a bayonet connection and which are provided with bayonet ridges 50, 60. Furthermore, it is not necessary that the extractable material which is used in a process of making a beverage, and which is placed in the interior space 21 of the brew chamber 20, is contained in a pad 10.

Variations to the disclosed embodiments can be understood and effected by those skilled in the art in practicing the claimed invention, from a study of the Figures, the description and the attached claims. In the claims, the word “comprising” does not exclude other steps or elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the present invention.

In the foregoing, a coffee maker 1 having a pad holder 30 for receiving and supporting at least one coffee pad 10 is described. The pad holder 30 can be connected to a brew chamber top portion 40 of the coffee maker 1 via a bayonet connection. To this end, both the pad holder 30 and the brew chamber top portion 40 are provided with bayonet ridges 50, 60. Contacting surfaces 51, 61 of the bayonet ridges 50, 60 comprise at least two portions having an inclined orientation with respect to each other.

In processes of establishing a coupling of the pad holder 30 to the brew chamber top portion 40 or detaching such a coupling, the pad holder 30 is rotated with respect to the brew chamber top portion 40, and the bayonet ridges 50 of the pad holder 30 slide along the bayonet ridges 60 of the brew chamber top portion 40. When horizontal portions 52, 62 of the contacting surfaces 51, 61 of the bayonet ridges 50, 60, which extend in a plane perpendicular to the axis of rotation about which the pad holder 30 is rotated, are positioned on top of one another, the pad holder 30 and the brew chamber top portion 40 are interconnected. A portion 53 of the contacting surface 51 of the bayonet ridges 50 of the pad holder 30, which is inclined with respect to the horizontal portion 52, plays an important role in guiding the pad holder 30 during a rotary movement of the pad holder 30, wherein a height level of the pad holder 30 with respect to the brew chamber top portion 40 is varied automatically owing to the inclined orientation of the portion 53.

1. Device (1) for making a beverage such as coffee from an extractable material and water that is forced through the extractable material, comprising a brew chamber (20) having a brew chamber casing (22) that encloses a brew chamber space (21) intended for containing a quantity of the extractable material, wherein the brew chamber casing (22) comprises at least two portions (30, 40) that can be mutually connected by means of a bayonet connection, wherein the two casing portions (30, 40) are provided with spaced-apart bayonet ridges (50, 60), wherein the bayonet ridges (50, 60) of the two casing portions (30, 40) are designed to engage each other when the bayonet ridges (50, 60) are put into contact with each other and the casing portions (30, 40) are rotated with respect to each other, and wherein each bayonet ridge (50, 60) comprises a surface (51, 61) which is suitable for contacting another bayonet ridge (50, 60) and which comprises at least two portions (52, 53, 62, 63, 64) having an inclined orientation with respect to each other.

2. Beverage maker (1) according to claim 1, wherein one (52, 62) of the portions (52, 53, 62, 63, 64) of the contacting surface (51, 61) of the bayonet ridge (50, 60) extends in a plane which is perpendicular to an axis of rotation about which the casing portions (30, 40) are rotatable with respect to each other.

3. Beverage maker (1) according to claim 1, wherein the contacting surface (61) of the bayonet ridges (60) of one (40) of the casing portions (30, 40) comprises at least three portions (62, 63, 64) having an inclined orientation with respect to each other, and wherein one (64) of these portions (62, 63, 64) has a substantially parallel orientation with respect to a portion (53) of the contacting surface (51) of the bayonet ridges (50, 60) of another one (30) of the casing portions (30, 40) when the casing portions (30, 40) are in a position for connecting to each other.

4. Beverage maker (1) according to claim 1, wherein one of the casing portions (30) is removable from the beverage maker (1) and is suitable for receiving and holding a quantity of extractable material.

5. Beverage maker (1) according to claim 4, wherein the casing portion (30) is provided with a handle (36) for easy manipulation by a user.

6. Beverage maker (1) according to claim 1, wherein each casing portion (30, 40) is provided with at least three bayonet ridges (50, 60).

7. Beverage maker (1) according to claim 1, wherein each casing portion (30, 40), including the bayonet ridges (50, 60), is manufactured from a synthetic resin material.

8. Component (30, 40) for use in a device (1) for making a beverage such as coffee from an extractable material and water that is forced through the extractable material, which component (30, 40) is designed for use as a portion of a casing (22) of a brew chamber (20) of the beverage maker (1), which casing (22) serves for enclosing a brew chamber space (21) which is intended for containing a quantity of the extractable material, the component (30, 40) comprising bayonet ridges (50, 60), wherein each bayonet ridge (50, 60) has a surface (51, 61) which comprises at least two portions (52, 53, 62, 63, 64) having an inclined orientation with respect to each other.

9. Component (30, 40) according to claim 8, which is provided with at least three bayonet ridges (50, 60).
